(19) United States
(12) Patent Application Publication
(10) Pub. No.: US 2017/0241004 A1
(43) Pub. Date: Aug. 24, 2017

(54) AMORPHOUS SOLIDIFYING PRECIOUS METAL ALLOY BASED ON PRECIOUS METALS

(71) Applicant: C. Hafner Gmbh + Co. KG, Wimsheim (DE)

(72) Inventors: Jochen Heinrich, Wimsheim (DE); Heinz-Günter Schenzel, Wimsheim (DE)

(21) Appl. No.: 15/591,745

(22) Filed: May 10, 2017

Related U.S. Application Data
(63) Continuation of application No. PCT/EP2015/002279, filed on Nov. 13, 2015.

(30) Foreign Application Priority Data
Nov. 13, 2014 (DE) 10 2014 016 723.2
Nov. 13, 2014 (DE) 20 1014 008 963.9

(51) Int. Cl. C22F 1/00; G04B 37/22; A44C 27/00; C22C 45/00; C22F 1/14

(52) U.S. Cl. CPC C22F 1/002; C22C 45/003; C22F 1/14; A44C 27/003; G04B 37/22; C22C 2200/02

(57) ABSTRACT

An amorphously solidifying noble metal alloy has the following composition of AaBbCc, wherein: A represents at least one noble metal from a group of platinum and palladium; B represents at least one element from a group of Al, Au, Ag and Cu; and C represents at least one element from a group of Ga and Ge. The mass fraction a lies in a region of 45-60 mass percent. The mass fraction b lies in the region of 39-55 mass percent. The mass fraction c lies in the region of 0-13 mass percent. Where platinum and palladium are both present, the amorphous noble metal alloy does not have aluminum as the sole alloy component from group B. The above mass fractions a, b and c, aside from typical admixtures, impurities and alloy tolerances, add up to 100 mass percent.

### CROSS-REFERENCE TO RELATED APPLICATIONS

This continuation application claims priority to PCT/EP2015/002279 filed on Nov. 13, 2015 which has published as WO 2016/074796 A1 and also the German application number 10 2014 016 723.2 filed on Nov. 13, 2014 and German application number 20 1014 008 963.9 filed on Nov. 13, 2014, the entire contents of which are fully incorporated herein with these references.

### DESCRIPTION

Field of the Invention

The invention relates to an amorphous solidifying precious metal alloy containing platinum and/or palladium, a method for its production as well as an article made on the basis of said precious metal alloy, in particular ornamental articles like a piece of jewelry, a watch, a watch case or a writing instrument.

Background of the Invention

Amorphous solidifying precious metal alloys based on precious metals are increasingly used, in particular in the jewelry or watch making industry, since they have an unusual combination of mechanical properties, in particular in respect to their hardness and elasticity, which is not achieved by any other material known up to now. Often amorphous solidifying precious metal alloys are characterized in comparison to conventional crystalline precious metal alloys of a comparable composition, by a significantly higher hardness.

A further advantage of amorphous solidifying metals is a combination of the mechanical properties with the possibility of a near net shape processing by casting or thermoplastic forming: The processing of such amorphous solidifying metals is performed without solidification shrinkage and leads to mechanically high loadable work-pieces. When casting such amorphous solidifying metals, the maximum achievable thickness of completely amorphous solidified workpieces is limited by the critical cooling rate of the respective precious metal alloy. By means of thermoplastic forming amorphous workpieces can be deformed or joined above the glass transition temperature T_{g}, so that in this way thin-walled, hollow, large-area and/or surface structured workpieces having dimensions beyond the critical thickness can be made.

The first amorphous precious metal alloy based on precious metals was a binary precious metal alloy in Au-Si-system. Starting from this system, the up to now most well-known amorphous precious metal alloy having the composition Au₄₉Ag_{5,5}Pd_{2,3}Cu_{26,9}Si_{16,3} was developed by Liquidmetal Technologies Inc., where the above-mentioned amounts are expressed in atomic percent. In terms of mass percent, this corresponds to Au_{76,3}Ag_{4,7}Pd_{1,9}Cu_{13,5}Si_{3,6}. This precious metal alloy having an amount of gold of 18 carat exhibits a hardness of 360 HV and exceeds the hardness value of a comparable crystalline precious metal alloy by more than 50%. A disadvantage of said precious metal alloy was an insufficient corrosion behavior, which is why this precious metal alloy was not widely used.

Furthermore, precious metal alloys on a platinum basis are known, e g. Pt_{42,5}Cu₂₇Ni_{9,5}P₂₁ as well as Pt₆₀Cu₁₆Co₂P₂₂, whereby the afore-mentioned amounts are once more expressed in atomic percent. In terms of mass percent, this corresponds to Pt_{73,9}Cu_{15,3}Ni₅P_{5,8} and Pt_{86,6}Cu_{4,5}Co_{0,9}P₅ respectively. This exclusively top-class precious metal alloys exhibit unusual high hardnesses of above 400 HV too. They are more corrosion resistant, when compared to the afore-mentioned amorphous solidifying gold alloys, due to a generally slower kinetics. The main disadvantage of said known amorphous precious metal alloys on a platinum basis is their large admixture with nickel-phosphor or phosphor respectively, which is disadvantageous to processing and recycling. In the afore-mentioned platinum alloys e. g. nickel-phosphor amounts and phosphor amounts of 21 and 22 atomic percent respectively are required in order to achieve a sufficient glass forming ability and lowest liquidus temperatures respectively in the system Pt—P.

Furthermore amorphous solidifying precious metal alloys on a palladium basis are known, e. g. Pd₄₀Co₃₀Ni₁₀P₂₀, wherein the amounts of the afore-mentioned alloy components are expressed in atomic percent once more. Expressed in mass percent, the afore-mentioned precious metal alloy has got the following composition: Pd₅₈Co₂₆Ni₈P₈. In this case once more the high amount of nickel-phosphor of together approximately 16 mass percent is disadvantageous.

U.S. Pat. No. 4,746,584 A1 describes metal electrodes, which are made of an amorphous metal according to the formula PtₚAₐD_{d}, wherein A stands for iridium, palladium, rhodium, ruthenium or a mixture thereof and D stands for boron, aluminum, arsenic, phosphor, antimony, germanium, silicon or a mixture thereof. The mass amount p is between 40-82%, the mass amount a between 1-40% and the one of d between 8-40%, whereby the amounts of p, a and d supplement to 100 wt.-%. This amorphous precious metal alloy is characterized in that it always contains two elements of the platinum group, namely always platinum and a further element of the platinum group.

From EP 0 267 318 A2 a crystalline precious metal alloy for jewelry purposes is known, which consists of 75 wt.-% to 99,5 wt.-% palladium as a basic metal and additives of metals of the 3. to 6. period of the periodic system of the elements.

DE 20 2009 013 202 U1 describes a crystalline platinum jewelry alloy, which comprises 50 wt.-% to 70 wt.-% platinum, 2 wt.-% to 15 wt.-% of at least one metal, chosen from the group indium, gallium, germanium, tin and zinc, and 0,5 wt.-% to 40 wt.-% silver or copper.

DE 10 2007 006 623 A1 describes a crystalline platinum alloy for the manufacturing of jewelry items, having the following composition, whereby the amounts given are in terms of weight-percent: 39-66% platinum, 5-30% palladium and 10-32% copper. Preferred embodiments of such alloys provide a composition of 44-46% platinum, 9-30% palladium and 24-27% copper and 39-41% platinum, 9-30% palladium and 29-52 copper respectively.

### SUMMARY OF THE INVENTION

It is the object of the present invention to create an amorphous solidifying precious metal alloy, which—apart from unavoidable mixtures and impurities—is free of nickel and/or phosphor. Furthermore, a method for the production of a semi-finished product made of the inventive precious metal alloy is to be provided. Further objects of the invention are to provide a semi-finished product, in particular for the production of jewelry, as well as the use of the inventive precious metal alloy for the manufacturing of an ornamental article as well as to provide an ornamental article.

The precious metal alloy according to the invention is characterized by a composition according to AₐB_{b}C_{c}, whereby A is at least one element of a group consisting of Pt and Pd, B is at least one element of a group, which consists of Al, Au, Ag, Cu, and C is at least one element of a group, which consists of Ga and Ge, whereby the mass amount a is between 45-60 mass percent, preferably between 45-59 mass percent, further preferably between 48 and 54 mass percent, the mass amount b is between 39-55 mass percent, preferably between 39-49 mass percent, further preferably between 40 to 47 mass percent, and the mass amount c is between 0-13 mass percent, preferably between 1-13 mass percent, further preferably between 2 to 10 mass percent and in particular preferably between 2 to 5 mass percent, whereby preferably, when platinum and palladium are simultaneously present, the precious metal alloy does not comprise aluminum as the sole alloy component of the group B, and whereby the afore-said amounts a, b and c, apart from usual admixtures and impurities, supplement to 100 mass percent.

By the inventive measures a platinum alloy is provided, which is free of nickel and/or phosphor, but still has a good glass forming ability. The inventive precious metal alloy is characterized by a high corrosion and tarnish resistance and is therefore, in particular, suited for the manufacturing of high quality workpieces such as e. g. jewelry articles.

Surprisingly, it has been found that these advantageous properties not only appear when platinum is used as a basis material, but also with palladium or a mixture of platinum and palladium, wherein the amount of palladium and platinum and palladium respectively is between 45 to 60 mass percent.

The precious metal alloys according to the invention have got the advantage that they do not contain nickel and/or phosphor. This simplifies their manufacturing and a metal recycling considerably. The precious metal alloys furthermore are unproblematic in respect to allergies, which is in particular of advantage in their application in the jewelry and watch making industry, where the respective ornamental pieces are often imminent and for a long period of time in direct contact with the skin.

The method for producing a semi-finished product from an amorphous solidifying precious metal alloy according to the invention provides that a mass amounts of at least one element of said group A, b mass amounts of at least one element of the aforesaid group B and c mass amounts of at least one element of afore-mentioned group C are alloyed and cast to the semi-finished product.

The semi-finished product according to the invention provides that it is made of the aforedescribed precious metal alloy according to the invention.

According to the invention, for manufacturing an ornamental article, in particular a piece of jewelry, a watch, a watch case, a watch band, a writing instrument or a part of such an item, an amorphous solidifying precious metal alloy is used, which is characterized by the composition Aa Bb Cc, whereby A designates at least one precious metal of a group consisting of platinum and palladium, B designates at least one element of a group consisting of Al, Au, Ag and Cu, C designates at least one element of a group consisting of Ga and Ge, whereby the mass amount a is in the range of 45-60 mass percent, preferably in the range of 45-59 mass percent, further preferably in the range of 48 to 54 mass percent, the mass amount b is in the range between 39-55 mass percent, preferably in the range of 39-49 mass percent, further preferably in the range of 40 to 47 mass percent, and the mass amount c is in the range of 0-13 mass percent, preferably in the range of 1-13 mass percent, further preferably in the range of 2 to 10 mass percent, and in particular preferably in the range of 2 to 5 mass percent, whereby preferably, when platinum and palladium are simultaneously present, the amorphous precious metal alloy does not contain aluminum as a single alloy component of the group B, and wherein the afore-mentioned mass amounts a, b and c, apart from usual admixtures, impurities and alloy tolerances, supplement to 100 mass percent.

The ornamental article according to the invention, in particular jewelry like a jewelry item, a watch, a watch case, a watch band, a writing instrument or a part of said articles provides that this article is entirely or partially made of an amorphous precious metal alloy according to the invention.

Further advantageous developments of the invention are the subject matter of the dependent claims.

### DETAILED DESCRIPTION OF THE PREFERRED EMBODIMENTS

Further details and advantages of the invention are disclosed in the exemplary embodiments, which are described below; the following values of amounts are mass percentages.

1. Platinum Alloys

1.1 System Pt—Ag—Cu

The first three exemplary embodiments of a precious metal alloy based on platinum belong to the system Pt—A—Cu.

A first exemplary embodiment of a precious metal alloy based on platinum is given by Pt_{53,2}Ag_{31,4}Cu_{12,2}Ga_{3,2}. This precious metal alloy is characterized by a favorable glass forming ability.

A second exemplary embodiment provides that the precious metal alloy is given by Pt₅₀Ag_{33,8}Cu_{13,2}Ga₃.

A third exemplary embodiment of a precious metal alloy is given by Pt₅₀Ag_{30,6}Cu_{11,9}Ge_{7,5}.

1.2 System Pt—Al—Cu

The next three exemplary embodiments relate to an amorphous solidifying precious metal alloy, whose main components are Pt—Al—Cu.

The fourth exemplary embodiment is a precious metal alloy Pt_{53,1}Al_{35,8}Cu_{7,9}Ga_{3,2}. The fifth exemplary embodiment is the precious metal alloy Pt₅₀Al_{38,5}Cu_{8,5}Ga₃.

The sixth exemplary embodiment provides a precious metal alloy Pt₅₀Al_{34,9}Cu_{7,7}Ge_{7,4}.

1.3 System Pt—Au—Ag—Cu

The seventh and eighth exemplary embodiment each describe a precious metal alloy of the system Pt—Au—Ag—Cu. The corresponding precious metal alloy are exemplarily given by Pt₅₀Au_{23,5}Ag₁₇Cu_{6,5}Ga₃ and Pt₅₀Au_{21,2}Ag_{15,3}Cu₆Ge_{7,5}.

The afore-mentioned eight exemplary embodiments therefore describe amorphous solidifying precious metal alloys based on platinum, which are characterized by the following composition: Ptₐ B_{b} C_{c}, whereby Pt stands for platinum, B characterizes at least one element of a group consisting of Al, Au, Ag, and Cu, and C defines at least one element of a group consisting of Ga and Ge. The parameter a stands for the platinum amount of the described precious metal alloy with 45-60 mass percent, the parameter b for 39 to 55 mass percent, preferably 39-49 mass percent, and the parameter c for 0-13 mass percent.

It is preferred that platinum is present in an amount of 45-60 mass percent, preferably between 45 and 59 mass percent, further preferably between 48-54 mass percent, in particular in an amount of 49 to 51 mass percent or 50-54 mass percent and for the last range in particular in an amount of 50-52 mass percent in the described precious metal alloy. The last mentioned ranges are characterized by a particularly favorable glass forming ability.

The amount b of the one or of several metals of the group B is between 39 to 55 mass percent, preferably 39-49 mass percent, preferably 40-47 mass percent and in particular 42-47 mass percent.

It is preferred that at least one of gallium and/or germanium is present in an amount c between 0-13 mass percent, preferably in an amount of 1-13 mass percent, preferably in an amount of 1-12 mass percent and here in particular between 2-10 mass percent and further in particular 2 to 5 mass percent in the described precious metal alloy. It is possible, but not preferred, that at least one of gallium and/or germanium is present in an amount c of 0-1 mass percent, so that in an extreme case (c=0) gallium and/or germanium is not contained in the afore described precious metal alloy.

2. Palladium Alloys

As mentioned at the beginning, it has surprisingly been shown that not only amorphous solidifying precious metal alloys based on platinum with the afore described composition exhibit the advantageous properties, but that platinum can be completely or partially substituted by palladium.

2.1 System Pd—Ag—Cu

The ninth exemplary embodiment is a precious metal alloy associated to the system Pd—Ag—Cu and consists of Pd₅₀Ag₃₄Cu₁₃Ga₃. In this case too, a favorable glass forming ability is given.

2.2 System Pd—Au—Ag—Cu

An exemplary embodiment of a precious metal alloy associated to this system is Pd₅₀Au_{20,2}Ag_{14,6}Cu_{5,7}Ge_{9,5}.

2.3

The afore described precious metal alloy can be characterized by Pdₐ B_{b} C_{c}, whereby Pd stands for palladium and B and C once more for at least one element of the afore-mentioned groups Al, Au, Ag, Cu and Ga, Ge respectively.

The amount a of palladium is once more between 45-60 mass percent, preferably 45-59 mass percent, further preferably 48-54 mass percent, further preferably 49-51 mass percent or 50-54 mass percent and hereby preferably 50-52 mass percent, whereby in particular in the last mentioned concentration ranges a particularly favorable glass forming ability is given.

The amount b of the one or the elements of the group B is between 39 to 55 mass percent, preferably 39-49 mass percent, further preferably 40-47 mass percent and hereby further preferably 42-47 mass percent.

The amount of gallium and/or germanium once more is between 0-13 mass percent, whereby the preferred ranges, which are specified above under no. 1 for the amorphous precious metal alloys based on platinum apply for palladium correspondingly.

It is preferred that the ratio of the atomic proportions of palladium and aluminum is equal or greater 4. This atomic ratio of palladium to aluminum corresponds to a mass ratio of palladium to aluminum of equal or greater 94/6; therefore it is preferred that the ratio of the amounts of palladium and aluminum is—expressed in mass ratios—equal or greater 15,67. An example for such an alloy is given by an alloy, which contains 45 to 60 mass percent palladium, 39 to 55 mass percent of at least two elements of the group B and at least one of gallium and/or germanium in an amount of 0 to 13 mass percent, but with the following condition: the first of the at least two metals of the group B is aluminum, whereby aluminum—corresponding to the amount of palladium in the range between 45 to 60 mass percent and the afore-mentioned ratio between palladium and aluminum—is present in an amount of at maximum 45/15,67 to 60/15,67, i. e. in an amount of 2,87 to 3,83 mass percent; the rest of the amount b of the at least two elements of the group B is then provided by a further element of the afore-mentioned group B. As in the cases described above, the preferred ranges for the amounts a, b and c apply here correspondingly.

3. Platinum-Palladium-Alloys

A precious metal alloy, which does not only contain platinum or palladium alone, but a combination of platinum and palladium—(Ptₐ₁ Pdₐ₂)a in an amount a=a₁+a₂ of 45-60 mass percent and in addition the afore-mentioned components, in which platinum is substituted by palladium up to 100 wt.-%, exhibits the afore-mentioned advantageous properties too, in particular in respect to the glass forming ability. As an example for such a precious metal alloy Pd₅₀Pd_{3,2}Ag_{31,4}Cu_{12,2}Ga_{3,2} is to be mentioned.

The platinum-palladium-alloys are characterized by (Ptₐ₁ Pdₐ₂)a B_{b} C_{c}, whereby for the mass amounts a, b and c once more the values disclosed in sections 1.3 and 2.3 apply.

It is once more preferred that the ratio of the atomic amounts of palladium and aluminum is equal or greater than 4. The explanations at the end of section 2.3 also apply for a combination of platinum and palladium correspondingly. As exemplary embodiment the following alloy is to be stated: Such alloy contains platinum and palladium in a total amount of 55 mass percent, whereby it is assumed that 50 weight percent platinum and 5 weight percent palladium are present. The amount of elements of the group B, here exemplarily aluminum and copper, is between 40 and 45 mass percent, whereby, if appropriate, a corresponding amount c of elements of the group C is contained. The amount of aluminum then is less than 0,32 mass percent and the amount of copper is in the range between 39,7 to 24,7 mass percent.

It is preferred that in the case when platinum and palladium are simultaneously present, one of these two elements, i. e. platinum or palladium, is present in an amount of more than 50 mass percent, in order to maintain the hallmarking capability of such a precious metal alloy with at least 50 mass percent of platinum or palladium, or in an amount of slightly less than 50 mass percent. As an example, the amount of platinum, assuming that the total amount of platinum and palladium is of 51-60 mass percent together, can be 50-59 mass percent, this means that palladium then is present in an amount of 1 mass percent only. The same applies vice versa, namely, that—once more as an example—palladium is present in an amount of 50-59 mass percent and hence the amount of platinum is only 1 mass percent. Of course any combinations are possible, e. g. that the amount of platinum and palladium respectively is 50-54 mass percent, preferably 50-52 mass percent, at a total amount of platinum and palladium of e. g. 59 mass percent, and the rest of the each other metal is then the amount lacking to 59 mass percent.

In the foregoing description of the exemplary embodiments of the amorphous platinum-palladium alloys it was assumed that several elements of the group B, i. e. of the group consisting of Al, Au, Ag, Cu, is present. But it is possible too that only one of these elements, as a single alloy element, of the group B is present in the described precious metal alloys. But it is preferred that aluminum is not present as the only element of group B. A combination of elements of the group B, which contains Al, is possible in said amorphous platinum-palladium alloys, as well as in the afore described amorphous platinum alloys and the amorphous palladium alloys. This is especially true when the amount a of platinum and palladium is between 45 and 59 mass percent, and is in the afore described sub ranges of the amount a.

4. Manufacturing and Further Processing

The manufacturing of the afore-mentioned precious metal alloys is, as an example, illustrated with reference to the first embodiment. Manufacturing of the further precious metal alloys having the composition Aₐ B_{b} C_{c} is done correspondingly: For the manufacturing of the precious metal alloy of the first exemplary embodiment 53,2 mass percent platinum, 31,4 mass percent silver, 12,2 mass percent copper and 3,2 mass percent gallium are alloyed and casted to form a massive semi-finished product. The semi-finished product is then melted in the next step and processed by a rapid solidification process. Preferred is an atomization of the melted mass in a flow of inert gas by means of a method and a device, which is e. g. described in the German patent DE 103 40 606 B4.

In an atomization of the melted mass with a starting temperature of 1250° C. in a nitrogen stream with a discharge pressure of 10 bar the material solidifies in splits of a second in the form of amorphous powders, which typically have an average particle diameter of 25 μm. The amorphous powder has got a glass transition temperature T_{g} of approximately 290° C. and a crystallization temperature Tₓ of approximately 450° C.

Further rapid solidification processes are a die-casting as well as a surface coating process such as thermal spraying or cold gas spraying.

The further processing of the plastified amorphous semi-finished product masses at temperatures above the glass transition temperature by means of the so called thermoplastic forming under pressure (TPF-method), as e. g. the die-casting of plastified amorphous semi-finished product masses by temperatures above the glass transition temperature is possible.

It is evident for the person skilled in the art from the above description that the ranges specified in each case apply in the context of conventional alloy tolerances. In addition, it is evident for him that by specifying the range limits all mass portions falling in the respective range are encompassed too.

In conclusion, it is to be stated that the described precious metal alloy is in particular suited for the manufacturing of ornamental articles such as jewelry items, watches, watch cases, writing instruments and components of the afore-mentioned goods.

What is claimed is:

1. An amorphous solidifying precious metal alloy, comprising:
AₐB_{b}C_{c}, wherein:
A designates at least one precious metal of a group consisting of platinum and palladium;
B designates at least one element of a group consisting of Al, Au, Ag and Cu;
C designates at least one element of a group consisting of Ga and Ge;
wherein the mass amount a is in the range of 45 to 60 mass percent;
wherein the mass amount b is in the range of 39 to 55 mass percent; and
wherein the mass amount c is in the range of 0 to 13 mass percent;
wherein, when platinum and palladium are simultaneously present, the amorphous solidifying precious metal alloy does not contain aluminum as a single alloy component of the group B; and
wherein the aforementioned mass amounts a, b and c, apart from usual admixtures, impurities and alloy tolerances, supplement to 100 mass percent.

2. The amorphous solidifying precious metal alloy according to claim 1, wherein the mass amount a is in the range of 45 to 59 mass percent.

3. The amorphous solidifying precious metal alloy according to claim 1, wherein the mass amount a is in the range of 48 to 54 mass percent.

4. The amorphous solidifying precious metal alloy according to claim 1, wherein the mass amount b is in the range of 39 to 49 mass percent.

5. The amorphous solidifying precious metal alloy according to claim 1, wherein the mass amount b is in the range of 40 to 47 mass percent.

6. The amorphous solidifying precious metal alloy according to claim 1, wherein the mass amount c is in the range of 1 to 13 mass percent.

7. The amorphous solidifying precious metal alloy according to claim 1, wherein the mass amount c is in the range of 2 to 10 mass percent.

8. The amorphous solidifying precious metal alloy according to claim 1, wherein the mass amount c is in the range of 2 to 5 mass percent.

9. The amorphous solidifying precious metal alloy according to claim 1, wherein the precious metal alloy consists of Ptₐ B_{b} and C_{c}, wherein Pt designate the precious metal platinum.

10. The amorphous solidifying precious metal alloy according to claim 1, wherein the precious metal alloy consists of Pdₐ B_{b} and C_{c}, wherein Pd designate the precious metal palladium.

11. The amorphous solidifying precious metal alloy according to claim 1, wherein the precious metal alloy consists of (Pta₁ Pda₂)ₐ B_{b} C_{c}, wherein the sum of the mass portions a₁ of platinum and a₂ of palladium, is—apart from usual admixtures and impurities—equal to the mass portion a.

12. The amorphous solidifying precious metal alloy according to claim 1, wherein the mass portion a is in the range of 49-51 mass percent or in the range of 50-54 mass percent, preferably in the range of 50-52 mass percent, and/or that the mass portion b is in the range of 42-47 mass percent.

13. The amorphous solidifying precious metal alloy according to claim 12, wherein the mass portion a is in the range of or in the range of 50-54 mass percent.

14. The amorphous solidifying precious metal alloy according to claim 12, wherein the mass portion a is in the range of 50-52 mass percent.

15. The amorphous solidifying precious metal alloy according to claim 1, wherein the amount of platinum or the amount of palladium is equal or greater than 50 mass percent, and/or that in the simultaneous presence of platinum and palladium the mass portion of one of these two elements is greater than 50 mass percent.

16. The amorphous solidifying precious metal alloy according to claim 1, wherein the precious metal is Pt_{53,2}Ag_{31,4}Cu_{12,2}Ga_{3,2} or Pt₅₀Ag_{33,8}Cu_{13,2}Ga₃.

17. A method for the manufacturing of a semi-finished product from an amorphous solidifying precious metal alloy according to claim 1, wherein a mass portions of at least one element of the group A, b mass portions of at least one element of the group B, and c mass portions of at least one element of the group C are alloyed and cast to a semifinished product.

18. The method according to claim 17, wherein the semi-finished product is melted and is further processed in a rapid solidification process.

19. The method according to claim 18, wherein an atomization of the molten material in an inert gas is used as a rapid solidification process, or that as rapid solidification process a die-casting or a surface coating like thermic spraying or cold gas spraying is used.

20. The method according to claim 17, wherein the amorphous semi-finished product is further processed by means of a thermoplastic forming under pressure (TPF-method).

21. The amorphous solidifying precious metal alloy according to claim 1, wherein a semi-finished product for manufacturing of ornamental items comprises, at least in part, the amorphous solidifying precious metal alloy.

22. The amorphous solidifying precious metal alloy according to claim 1, wherein an ornamental article comprises, at least in part, the amorphous solidifying precious metal alloy, the ornamental article comprising a particular a piece of jewelry, a watch, a watch case, a watch band, a writing instrument or a part of such an article.

23. The amorphous solidifying precious metal alloy according to claim 1, wherein an ornamental article is completely or at least partially made from the amorphous solidifying precious metal alloy, the ornamental article comprising a particular a piece of jewelry, a watch, a watch case, a watch band, a writing instrument or a part of such an article.

24. An ornamental article, wherein the ornamental article is completely or at least partially made of an amorphous solidifying precious metal alloy, the amorphous solidifying precious metal alloy comprising:
AₐB_{b}C_{c}, wherein:
A designates at least one precious metal of a group consisting of platinum and palladium;
B designates at least one element of a group consisting of Al, Au, Ag and Cu;
C designates at least one element of a group consisting of Ga and Ge;
wherein the mass amount a is in the range of 45 to 60 mass percent;
wherein the mass amount b is in the range of 39 to 55 mass percent; and
wherein the mass amount c is in the range of 0 to 13 mass percent;
wherein, when platinum and palladium are simultaneously present, the amorphous solidifying precious metal alloy does not contain aluminum as a single alloy component of the group B; and
wherein the aforementioned mass amounts a, b and c, apart from usual admixtures, impurities and alloy tolerances, supplement to 100 mass percent.

25. The ornamental article of claim 24, wherein the ornamental article is a piece of jewelry, a watch, a watch case, a watch band, a writing instrument or a part of such an article.
